(19) United States
(12) Patent Application Publication
(10) Pub. No.: US 2025/0094804 A1
(43) Pub. Date: Mar. 20, 2025

(54) AUTHENTICATED CUSTOMIZATION OF MACHINE-LEARNING MODELS

(71) Applicant: Oracle International Corporation, Redwood Shores, CA (US)

(72) Inventors: Shashi Prasad Suravarapu, San Ramon, CA (US); Amitabh Saikia, Mountain View, CA (US); Srinivasa Phani Kumar Gadde, Fremont, CA (US); Diego Andres Cornejo Barra, Chicago, IL (US); Cody Nicholas Maheu, Nashua, NH (US); Yuanxu Wu, Sunnyvale, CA (US); Laukik Satish Mujumdar, Bellevue, WA (US); Daniel Bruce Carter, Redmond, WA (US); Zachary Jon-Christian Medeck, Kent, WA (US); Jobinesh Purushothaman Manakkattil, Foster City, CA (US); Sangeet Dahal, Modesto, CA (US); Shweta Shyamsunder Gupta, Covington, WA (US)

(73) Assignee: Oracle International Corporation, Redwood Shores, CA (US)

(21) Appl. No.: 18/883,407

(22) Filed: Sep. 12, 2024

Related U.S. Application Data
(60) Provisional application No. 63/583,214, filed on Sep. 15, 2023.
(60) Provisional application No. 63/583,234, filed on Sep. 15, 2023.

(51) Int. Cl. G06N 3/082; G06N 3/0455

(52) U.S. Cl. CPC G06N 3/082; G06N 3/0455

(57) ABSTRACT

Techniques are disclosed for providing an authenticated model customization for a machine-learning model. A cloud service provider platform accesses a message including, at least, timestamp data and user identification data. A training group of data entities is identified based on the data in the message. A training dataset is determined based on the training group of data entities. A machine-learning model is modified based on the training dataset. The modified machine-learning model is provided during an authenticated network session associated with the user identification data. In some embodiments, the modification of the machine-learning model is removed based on a determination that the authenticated network session had ended.

### CROSS-REFERENCE TO RELATED APPLICATIONS

The present application claims the benefit of and priority to U.S. Provisional Application No. 63/583,214, filed Sep. 15, 2023, and U.S. Provisional Application No. 63/583,234, filed Sep. 15, 2023, the entire contents of which are incorporated herein by reference for all purposes.

### BACKGROUND

Clinical environments such as healthcare facilities often include different healthcare providers working together and communicating with one another to treat patients. Documenting patient encounters, capturing information conveyed during those encounters and/or pertaining to events occurring before and/or after the encounters, populating patient records such as electronic health records, and healthcare practice management are integral parts of the practice of many healthcare providers and important to ensuring high-quality healthcare. Traditional means for performing tasks associated with providing healthcare often involve several different devices such as listening devices, portable electronic devices, workstations, and the like and end users who are equipped with the training, knowledge, experience, and skills to properly utilize these devices and participate in the healthcare process. Relying on different devices and qualified end users to perform clinical tasks is cumbersome, time and resource intensive, costly, and reduces efficiencies, which may lead to lower-quality healthcare.

In certain approaches, Artificial Intelligence (AI)-based models are included in some digital assistance tools. In certain approaches, AI-based models have been used in healthcare settings to facilitate care and management of patient populations. However, these models do not generally perform as expected in a target environment, such as a healthcare setting. It is a non-trivial and challenging task to build AI-based models for a target environment because these models require specific knowledge in certain fields (for example, healthcare information) and the application of certain techniques that may be relevant to the target environment. Thus, it may be desirable to build AI-based models for a target domain.

### BRIEF SUMMARY

Techniques are disclosed herein for providing authenticated customizations of machine-learning models.

In some embodiments, a computer-implemented method includes accessing a message. The message includes timestamp data and user identification data. The computer-implemented method includes identifying a training group of data entities including patient information. Each data entity in the training group is included in an appointment dataset associated with the user identification data. Each data entity in the training group includes appointment time data within a time window that is based on the timestamp data. The computer-implemented method includes determining at least one training dataset. The at least one training dataset is determined based on the training group of the data entities. The computer-implemented method includes modifying at least one pre-trained machine-learning model based on the at least one training dataset. The computer-implemented method includes providing the at least one modified pre-trained machine-learning model during an authenticated network session associated with the user identification data.

In some embodiments, the computer-implemented method includes accessing an additional message. The additional message indicates an end of the authenticated network session associated with the user identification data. The computer-implemented method includes removing the modification that is based on the at least one training dataset. The modification is removed from the at least one pre-trained machine-learning model.

In some embodiments, the training group of the data entities comprises secured data entities. The authenticated network session grants access to the patient information included in the secured data entities. The access is granted to a client device that is authenticated via the user identification data.

In some embodiments, the message is generated in response to a client application executing on a client device associated with the user identification data. The message indicates that the client application is granted access to a computing resource.

In some embodiments, the time window includes a forward time window, a backwards time window, or an extended time window. The forward time window includes a first period of time subsequent to the timestamp data. The backward time window includes a second period of time prior to the timestamp data. The extended time window includes a most recent appointment time data item.

In some embodiments, the computer-implemented method includes accessing an additional message during the authenticated network session. The additional message includes the user identification data and modified timestamp data. The computer-implemented method includes determining an additional training dataset that is based on at least one additional data entity. The additional data entity is included in the appointment dataset associated with the user identification data. The additional data entity includes additional appointment time data that is within an additional time window based on the additional timestamp data. The computer-implemented method includes further modifying the at least one pre-trained machine-learning model based on the additional training dataset. The computer-implemented method includes providing the at least one further modified pre-trained machine-learning model during the authenticated network session associated with the user identification data.

In some embodiments, further modifying the at least one pre-trained machine-learning model includes removing the modification that is based on the at least one training dataset. The modification that is based on the at least one training dataset is removed from the at least one pre-trained machine-learning model.

In some embodiments, identifying the training group of data entities includes determining a group of data entities associated with the user identification data. Identifying the training group of data entities includes determining a first subset of the group of data entities and a second subset of the group of data entities. Each data entity included in the first subset is included in the appointment dataset associated with the user identification data. Each data entity included in the second subset includes the appointment time data within the time window. Identifying the training group of data entities includes selecting a third subset of the group of data entities from the group of data entities associated with the user identification data. Each data entity in the third subset is included in the first subset and the second subset. The training group of the data entities includes each data entity included in the third subset.

In some embodiments, the at least one pre-trained machine-learning model includes a speech recognition pre-trained machine-learning model. The at least one training dataset comprises a speech recognition training dataset. Determining the speech recognition training dataset includes extracting text data from the training group of the data entities. The text data is associated with the patient information included in the training group of the data entities. Determining the speech recognition training dataset includes generating a customization recognition vocabulary that includes the extracted text data. The speech recognition training dataset includes the customization recognition vocabulary. Modifying the at least one pre-trained machine-learning model based on the at least one training dataset includes modifying the speech recognition pre-trained machine-learning model based on the speech recognition training dataset.

In some embodiments, the computer-implemented method includes accessing an additional message. The additional message indicates an end of the authenticated network session associated with the user identification data. The computer-implemented method includes removing the speech recognition training dataset that includes the customization recognition vocabulary. The speech recognition training dataset is removed from the speech recognition pre-trained machine-learning model.

In some embodiments, the at least one pre-trained machine-learning model includes a language pre-trained machine-learning model. The at least one training dataset comprises a language training dataset. Determining the language training dataset includes identifying a group of data objects in the training group of the data entities. The group of data objects is associated with the patient information included in the training group of the data entities. Determining the language training dataset includes modifying a respective searchable data entity for each particular data object in the group of data objects. The respective searchable data entity is modified to include the particular data object. The language training dataset includes the respective searchable data entity for each particular data object in the group of data objects. Modifying the at least one pre-trained machine-learning model based on the at least one training dataset includes modifying the language pre-trained machine-learning model based on the language training dataset.

In some embodiments, the computer-implemented method includes accessing an additional message. The additional message indicates an end of the authenticated network session associated with the user identification data. The computer-implemented method includes removing the language training dataset that includes the respective searchable data entity for each particular data object in the group of data objects. The language training dataset is removed from the language pre-trained machine-learning model.

Some embodiments include a system that includes one or more processing systems and one or more computer-readable media storing instructions which, when executed by the one or more processing systems, cause the system to perform part or all of the operations and/or methods disclosed herein.

Some embodiments include one or more non-transitory computer-readable media storing instructions which, when executed by one or more processing systems, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Features, embodiments, and advantages of the present disclosure are better understood when the following Detailed Description is read with reference to the accompanying drawings.

FIG. 1 is a high-level diagram depicting an example of a computing environment that includes capabilities for providing customized digital assistance tools, according to certain embodiments.

FIG. 2 depicts a simplified block diagram of a computing environment that includes a cloud service provider platform configured to provide an authenticated model customization for a machine-learning model, according to certain embodiments.

FIG. 3 depicts a simplified block diagram of a computing environment that includes a cloud service provider platform configured for providing authenticated model customizations for pre-trained machine-learning models, according to certain embodiments.

FIG. 4 depicts an example process flow for generating an authenticated customization for a machine-learning model, according to certain embodiments.

FIG. 5 depicts an example process flow for modifying an authenticated customization for a machine-learning model, according to certain embodiments.

FIG. 6 depicts an example process flow for determining a training group of data entities, from which an authenticated customization for a machine-learning model can be determined, according to certain embodiments.

FIG. 7 is a block diagram illustrating one pattern for implementing a cloud infrastructure as a service system, according to certain embodiments.

FIG. 8 is a block diagram illustrating another pattern for implementing a cloud infrastructure as a service system, according to certain embodiments.

FIG. 9 is a block diagram illustrating another pattern for implementing a cloud infrastructure as a service system, according to certain embodiments.

FIG. 10 is a block diagram illustrating another pattern for implementing a cloud infrastructure as a service system, according to certain embodiments.

FIG. 11 is a block diagram illustrating an example computer system, according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Many healthcare providers use digital assistance tools to improve patient care, such as digital assistance tools for transcribing notes or spoken dialog, identifying potential diagnoses, accessing patient electronic health records, scheduling appointments or procedures, and other types of digital assistance tools. Because digital assistance tools are utilized for various aspects of patient care, some digital assistance tools can be improved (e.g., improved efficiency, improved accuracy, etc.) based on various types of information, such as by including different types of information in some cases. For example, a digital assistance tool for reducing scheduling conflicts might be improved based on information indicating appointment duration or procedure preparation time, while a digital assistance tool for automatic speech recognition might be improved by information indicating pronunciation or spelling of a patient's name. In some cases, healthcare providers who use multiple digital assistance tools desire each of the tools used to provide high-quality service (e.g., high accuracy, high efficiency, etc.) while not wishing to spend time or effort determining particular information that is available to each particular digital assistance tool. In addition, various digital assistance tools may utilize information in different ways, leading to various techniques for training, updating, or other types of modification of the digital assistance tools. In some cases, an operator of a healthcare computing environment may expend significant resources (e.g., time, financial, etc.) to coordinate training, updates or other modifications for multiple digital assistance tools that are used within the healthcare computing environment. There is a need to provide healthcare providers and other professionals with high-quality digital assistance tools that do not burden the end user with efforts to keep the digital assistance tools operating at a high-quality level of service.

Some traditional techniques use machine-learning training to modify some digital assistance tools, such as periodic training of machine-learning models included in such tools. However, contemporary techniques for machine-learning training may require prohibitive amounts of time or computing resources, resulting in a reduced practical utility of the contemporary techniques for machine-learning training. For example, a healthcare computing environment that includes a large quantity of electronic health records (e.g., tens of thousands of records or more) may be unable to spend time or computing resources (e.g., processing power) to use all of the electronic health records to update training for a machine-learning model includes in a digital assistance tool. In some scenarios, such as healthcare computing environments that serve emergency wards or other 24-hour patient care facilities, traditional periodic training of a machine-learning model may be impractical, as removing access to the digital assistance tool might negatively impact patient care during training. In addition, reducing a frequency of traditional periodic training of the machine-learning model may reduce usefulness of the digital assistance tool. For example, a digital assistance tool that is one week behind on training (e.g., has not been updated to include a previous week of updates to patient electronic health records) could negatively impact patient care, such as by failing to incorporate recent changes to a patient's condition.

Additionally, traditional techniques for machine-learning training may reduce security of protected information. For example, a digital assistance tool may include a machine-learning model that is trained based on contemporary techniques, such as training using data from a large quantity of electronic health records. However, the contemporary machine-learning training techniques may negatively impact security for protected patient information that is included in the electronic health records, such as by exposing the protected patient information to any user of the machine-learning model trained by the contemporary techniques. This reduction of security for protected information may also occur within a secured computing environment. For example, a secured healthcare computing environment may include a digital assistance tool that is accessible by multiple authenticated users of the healthcare computing environment. However, the multiple authenticated users may not be authorized to access all protected information within the secured healthcare computing environment, e.g., various authenticated users may be authorized to access different portions of protected information in different electronic health records. In this example, training a machine-learning model in the digital assistance tool based on contemporary machine-learning training techniques may inadvertently expose particular portions of protected information to one or more authenticated users who are not authorized to view the particular portions of protected information.

Therefore, it may be desirable to improve upon the traditional techniques for machine-learning training by providing a technique for authenticated customizations of machine-learning models.

The developed approach described herein addresses these challenges and others by providing techniques for generating and/or applying an authenticated model customization to machine-learning model. In various embodiments, a computer-implemented method includes accessing a message. The message includes timestamp data and user identification data. The computer-implemented method includes identifying a training group of data entities including patient information. Each data entity in the training group is included in an appointment dataset associated with the user identification data. Each data entity in the training group includes appointment time data within a time window that is based on the timestamp data. The computer-implemented method includes determining at least one training dataset. The at least one training dataset is determined based on the training group of the data entities. The computer-implemented method includes modifying at least one machine-learning model based on the at least one training dataset. The computer-implemented method includes providing the at least one modified machine-learning model during an authenticated network session associated with the user identification data.

### Authenticated Customization Techniques

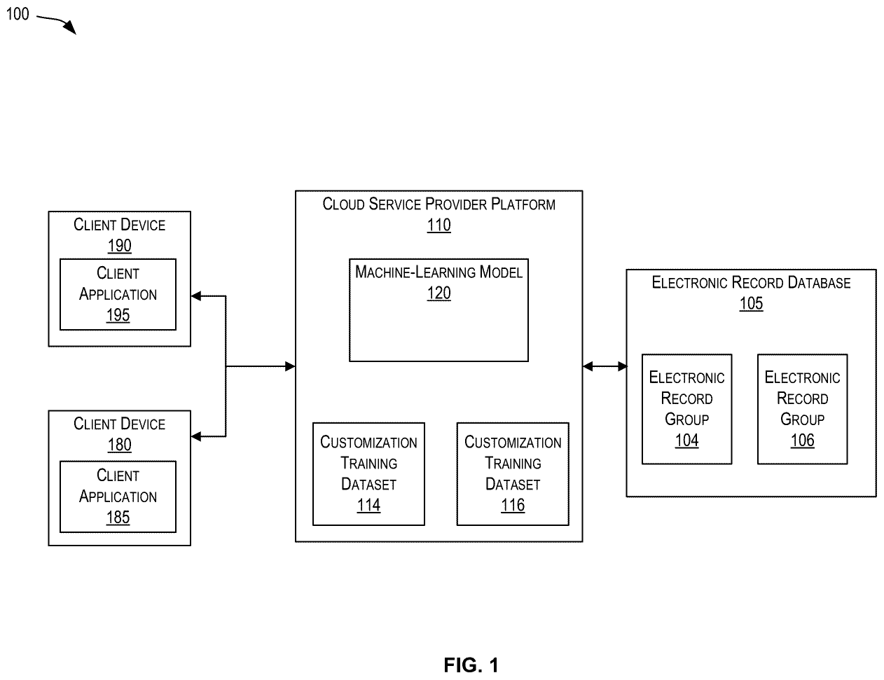

FIG. 1 is an example of a computing environment 100 that includes capabilities for providing various services to users. The end-users (e.g., clinicians such as doctors and nurses) may utilize the various services provided by the cloud service provider platform 110 to perform various functions. In FIG. 1, the computing environment 100 includes a cloud service provider platform 110, at least one data repository, such as an electronic record database 105, and at least one client device, such as a client device 190 and a client device 180. The cloud service provider platform 110 includes capabilities for providing various services, including cloud services, to subscribers (e.g., end-users) of the cloud service provider platform 110. In the computing environment 100, the cloud service provider platform 110 provides one or more services, including the cloud services, to additional computing systems included in (or in communication with) the computing environment 100. For example, the cloud service provider platform 110 can provide one or more digital services to the client devices 190 and 180.

The services provided by the cloud service provider platform 110 may include, but are not limited to, digital assistant services, authentication services, user management services, frontend services (e.g., a single entry point to all services), and other management services. The various services may be implemented on one or more servers of the cloud service provider platform 110 using one or more machine-learning models such as machine-learning model 120. Additionally, the various services may be provided to end-users who subscribe to the services provided by the platform 110. In a certain implementation, the services provided by the cloud service provider platform 110 may be implemented as machine-learning-based or artificial intelligence (AI)-based digital assistance tools that may be provided to end-users. For instance, the cloud service provider platform 110 can provide one or more digital assistance tools that utilize one or more machine-learning models, such as the machine-learning model 120. In some cases, the machine-learning model 120 could be utilized in a speech service in which the machine-learning model 120 implements automatic speech recognition (ASR) technology to transform audio-based content into text. Using ASR technology, humans can communicate with a computer interface using their voice in a manner similar to actual human conversations. In some cases, the machine-learning model 120 could be utilized in a dictation service in which the machine-learning model 120 implements large language model (LLM) technology to generate text (e.g., summarizations, notetaking, etc.) from input data. The machine-learning model 120 can be any kind of machine-learning model can facilitate the providing of the various services by the cloud service provider platform 110. Examples of machine-learning models include but are not limited to: pre-trained machine-learning models, open-source machine-learning models, licensed machine-learning models, generative machine-learning models, transformer-based machine-learning models, and the like. In some cases, the machine-learning model 120 (or another service provided by the cloud service provider platform 110) can be configured to serve as an artificial intelligence-driven (AI-driven) conversational-type interface for the platform 110, such as a conversational-type interface service that can conduct conversations with end users (e.g., those using the client devices 190 or 180) and perform functions and/or tasks based on the information conveyed by and/or ascertained from those conversations and other sources. The example conversational-type interface service can be configured with and/or configured to access natural language understanding (NLU) capabilities such as natural language processing, named entity recognition, intent classification, and so on. In some implementations, the example conversational-type interface service can be skill-driven in which the example service includes bots that each include one or more skills for conducting conversations and performing functions and/or tasks. In some implementations, the example conversational-type interface service can be LLM-based and agent-driven in which agent(s) coordinate with LLM(s) for conducting conversations and performing functions and/or tasks. Examples of skill-driven and LLM-based and agent-driven digital assistants are described in U.S. patent application Ser. No. 17,648,376, filed on Jan. 19, 2022, and U.S. patent application Ser. No. 18/624,472, filed on Apr. 2, 2024, each of which are incorporated by reference as if fully set forth herein.

Various end-users may interact with the cloud service provider platform 110 using one or more client devices (e.g., 190, 180) that may be communicatively coupled to one or more servers associated with the cloud service provider platform 110, via one or more communication channels. Examples of a client device can include a mobile phone, a tablet, a desktop computer, or other suitable client devices that can communicate digitally with the cloud service provider platform 110. The users can interact with the various services via a user interface (UI) of an application installed on the client devices 190 or 180, such as a client application 195 installed on the client device 190 or a client application 185 installed on the client device 180.

The computing environment 100 additionally includes an electronic record database 105. The electronic record database 105 may be a storage device, such as a physical or cloud-based storage device in communication with the cloud service provider platform 110. The electronic record database 105 may be configured to store electronic information. Each electronic record can be linked to other electronic records. In some cases, the cloud service provider platform 110 and the electronic record database 105 may be configured to securely store or transmit electronic information that is protected. Examples of protected information can include health information, financial information, personal information, or other types of protected information. Examples of secure storage or transmission of electronic information can include encryption, hashing, randomization, access authentication, or other techniques to secure electronic information.

The computing environment 100 depicted in FIG. 1 is merely an example and is not intended to unduly limit the scope of claimed embodiments. One of ordinary skill in the art would recognize many possible variations, alternatives, and modifications. For example, in some implementations, the computing environment 100 can be implemented using more or different services than those shown in FIG. 1, may combine two or more services, or may have a different configuration or arrangement of services.

In some cases, the computing environment 100 is a healthcare computing environment, such as a healthcare computing environment that is configured for use by healthcare providers within a healthcare setting (e.g., a hospital, a medical practice, an urgent care facility, an outpatient facility, etc.). In FIG. 1, the computing environment 100 can be configured to assist multiple end-users who are healthcare providers, such as assistance with care and treatment for multiple patients. The term healthcare provider generally refers to healthcare practitioners and professionals including, but not limited to: physicians (e.g., general practitioners, specialists, surgeons, etc.); nurse professionals (e.g., nurse practitioners, physician assistants, nursing staff, registered nurses, licensed practical nurses, etc.); other professionals (e.g., pharmacists, therapists, technicians, technologists, pathologists, dietitians, nutritionists, emergency medical technicians, psychiatrists, psychologists, counselors, dentists, orthodontists, hygienists, etc.). For instance, in the computing environment 100, the end-users can utilize the functionality provided by the services of the cloud service provider platform 110 to view, edit, or manage a patient's electronic health record, examine or treat patients, facilitate the treatment of a patient such as documenting the doctor-patient encounter, generating medication or laboratory orders, and the like, perform administrative tasks such as scheduling appointments, manage patient populations, provide customer service to facilitate operation of the computing environment 100, and so on.

In the computing environment 100, a patient can be associated with one or more electronic health records, such as electronic health records stored in the electronic record database 105. Each electronic health record associated with a patient can be linked to other electronic health records associated with the patient. In some embodiments, the electronic record database 105 stores electronic health records as one or more data entities, such as database records, digital files, or other types of data objects. For example, the electronic record database 105 stores a particular electronic health record as one or more data entities that describe health information for a patient associated with the particular electronic health record, such as data entities that respectively describe personal information, appointment information, medical procedures (e.g., scheduled procedures, completed procedures, etc.), diagnoses, prescriptions, notes by healthcare providers, or other types of digitally stored health information. In some embodiments, the electronic record database 105 includes one or more electronic health records that are digitally secured data entities, such as electronic health records that include protected information for associated patients. Examples of protected information can include personal identification for a patient (e.g., name, address, etc.), health information for a patient (e.g., diagnoses, scheduled procedures, provider notes, prescriptions, etc.), financial information for a patient (e.g., insurance data, payment plan data, etc.), or other types of patient-related information that are identified in the computing environment 100 as protected information.

In a healthcare setting in which the computing environment 100 could be used, dialog is prevalent between participants of the healthcare setting. For example, at any given moment, there could be dialog or conversation among patients and healthcare providers, among multiple healthcare providers, or among other groups of participants in the example healthcare setting. In some embodiments, digital entities could participate in some dialogs, such as dialog or conversation of a healthcare provider with one or more digital assistance tools (e.g., a diagnosis digital assistance tool, a recordkeeping digital assistance tool, etc.) In some cases, dialog in the example healthcare setting involves information relevant to one or more electronic health records, such as information regarding the care, treatment, observation, diagnoses for one or more patients. In some other cases, dialog involves logistics of patient care, such as what time is a physician's appointment, what procedure a nurse is to perform, what information is relevant about a particular patient for a particular appointment, and the like. In some embodiments, AI digital assistance tools can participate in dialogs (or other forms of providing healthcare) in the example healthcare setting. For example, a healthcare provider such as an internist could use an AI-based tool to automatically organize recorded notes from an appointment with a patient. In another example, a healthcare provider such as a lab technician could use an AI-based tool to automatically file laboratory results (e.g., bloodwork) in a patient's electronic health record. In yet another example, an AI-based tool could automatically generate a health summary report for each patient having an appointment with a healthcare practitioner on a particular day, to allow the healthcare practitioner to quickly review medical information for each patient scheduled that day.

In FIG. 1, the computing environment 100 includes capabilities to protect patient information, such as secured electronic health records in the electronic record database 105, while providing one or more digital assistance tools for multiple healthcare providers. Examples of digital assistance tools can include authentication services, ASR transcription services (e.g., automatic voice-to-text transcription of dialog among patients or healthcare providers), LLM dictation services, or other types of digital assistance tools. In the computing environment 100, the cloud service provider platform 110 includes one or more machine-learning models, such as the machine-learning model 120. In some cases, the machine-learning model 120 is a pre-trained machine-learning model. In addition, the cloud service provider platform 110 provides digital assistance tools to healthcare providers via one or more additional computing systems, such as the client devices 190 or 180. For example, each of the client devices 190 and 180 is associated with a respective healthcare provider, such as a particular person who is using a particular client device. In addition, each of the client devices 190 and 180 accesses, e.g., on behalf of the respective healthcare provider, the digital assistance tools provided by the cloud service provider platform 110.

In some cases, one or more digital assistance tools are accessed via a client application that operates on a client device in the computing environment 100. For example, the client device 190 includes the client application 195 and the client device 180 includes the client application 185. Each of the client applications 195 and 185 is configured to access one or more digital assistance tools provided by the cloud service provider platform 110, such as the machine-learning model 120.

Examples of healthcare providers can include doctors, nurses, technicians, pharmacists, or any other healthcare personnel who interact with the cloud service provider platform 110, e.g., via the client devices 190 or 180. In an example scenario, healthcare providers can view, update, or otherwise access electronic health records for patient in their care by utilizing the client devices 190 or 180. Examples of client devices, such as the devices 190 or 180, can include electronic devices such as mobile phones, tablets, workstations, and other computing devices to view, edit, and otherwise access a patient's electronic health record.

In some embodiments, each of the client devices 190 and 180 is utilized by a respective healthcare provider, such as a particular mobile computing device that is associated with a particular healthcare provider in the computing environment 100. In this example scenario, the same healthcare provider utilizes the same client device, such as bringing the particular mobile computing device to each examination room (or other healthcare location) for appointments with multiple patients. In additional or alternative embodiments, each of the client devices 190 and 180 is utilized by multiple healthcare providers, such as a particular desktop computing device that is associated with a particular healthcare resource (e.g., a location, medical equipment, etc.) In this additional example scenario, multiple healthcare providers utilize a same client device, such as multiple healthcare providers who utilize a stationary (or mostly stationary) computing workstation that is included in (or otherwise associated with) a particular X-ray machine.

In the computing environment 100, the cloud service provider platform 110 is configured to require authentication, e.g., user identification information, from each healthcare provider who utilizes one or more of the client devices 190 or 180. For example, if one or more of the client devices 190 or 180 is utilized by a particular associated healthcare provider, the cloud service provider platform 110 could require authentication from the associated healthcare provider on a recurring basis (e.g., every hour, every occasion that the healthcare provider moves to a new location in the example healthcare setting, etc.). As an additional example, if one or more of the client devices 190 or 180 is utilized by multiple healthcare providers, the cloud service provider platform 110 could require respective authentication for each particular healthcare provider who utilizes the client device. Example techniques for authentication can include username/password combinations, biometric data, multi-factor security techniques, or other types of techniques to authenticate a user or user device attempting to access a computing system.

In FIG. 1, the computing environment 100 includes one or more digital security safeguards to prevent access (e.g., by unauthorized individuals, unauthorized computing systems, etc.) to protected information, such as protected patient information stored in secured data entities in the electronic record database 105. For example, one or more of the cloud service provider platform 110 or the electronic record database 105 is configured to require authentication from a user prior to permitting the user to access the secured data entities in the electronic record database 105. In addition, the cloud service provider platform 110 is configured to require authentication from a user prior to permitting the user to access the machine-learning model 120, or additional digital assistance tools provided by the cloud service provider platform 110. In some cases, the cloud service provider platform 110 (or additional computing systems in the computing environment 100) improves security for protected patient information by requiring authentication from each user (or utilized client device). In some cases, the cloud service provider platform 110 (or additional computing systems in the computing environment 100) improves security for protected patient information by preventing a particular authenticated user from accessing particular secured data entities that the authenticated user is not authorized to access. In some cases, authorization to access a particular secured data entity is based on a user role or other characteristic. For example, an authenticated user who is a doctor may be authorized (e.g., permitted) to access electronic health records for patients who receive care from the doctor and may be prevented from accessing electronic health records for additional patients who do not receive care from the doctor. In this example, the authenticated doctor may be authorized to access, in the electronic health records for her assigned patients, particular secured data entities that describe medical health information (e.g., medical history) and may be prevented from accessing additional secured data entities that describe financial health information (e.g., insurance availability). As an additional example, an authenticated user who is a scheduling specialist may be authorized to access, for any patient, particular secured data entities that describe scheduling health information (e.g., scheduled appointments or procedures) and may be prevented from accessing additional secured data entities that describe other types of health information (e.g., diagnoses, prescriptions, etc.). In some cases, the cloud service provider platform 110 improves security of protected patient information within the computing environment 100 by limiting access, by authenticated users, to electronic health records or secured data entities included in electronic health records. In the computing environment 100, each particular authenticated user is permitted to access particular electronic health records or particular secured data entities for which the particular authenticated user is authorized, and each particular authenticated user is denied access to additional electronic health records or additional secured data entities for which the particular authenticated user is unauthorized.

In the example healthcare setting, healthcare providers who utilize one or more digital assistance tools provided by the cloud service provider platform 110 may desire the tools to provide high-quality assistance in providing patient care. Examples of high-quality assistance can include transcribing spoken dialog with high accuracy, identifying potential diagnoses with high accuracy, efficient (e.g., fast, accurate) access to a correct electronic health record for a particular patient, or other types of digital assistance that have sufficiently high quality to improve care that is provided to the patient. For example, healthcare providers who utilize the machine-learning model 120 may desire the utilized machine-learning model(s) to be trained with most recently available data, such as data that includes recent (e.g., same day) updates to patient information. In the computing environment 100, training the machine-learning model 120 can improve quality of patient care, such as increasing accuracy of patient-specific details, such as the patient's name, diagnoses, prescriptions, or other patient information. In addition, digital security safeguards to protect patient information may prevent the cloud service provider platform 110 from training the machine-learning model 120 using patient data, such as to improve protection of patient health information by preventing a particular user from accessing patient information, via a trained model, that the particular user is not authorized to view. In some cases, the existence of multiple goals for training a machine-learning model create a technical problem within the computing environment 100. For example, users of the computing environment 100 may wish to satisfy a first goal to improve quality of assistance provided by the trained machine-learning model and also a second goal to prevent unauthorized access to patient information via the trained machine-learning model. In some cases, these example goals can create a conflict, e.g., improving patient information security conflicting with maximizing machine-learning model quality, that is not resolved by typical training techniques for machine-learning models.

In the computing environment 100, the cloud service provider platform 110 is configured to customize one or more trained machine-learning models using customization data that is associated with a particular authenticated user. Additionally or alternatively, the cloud service provider platform 110 is configured to remove from the one or more trained machine-learning models the customization data associated with the particular authenticated user, such as in response to determining that the particular authenticated user has logged out from the cloud service provider platform 110. In some embodiments, the described configuration of the cloud service provider platform 110 provides a solution to the example conflict between the first and second goals described above. For example, customizing a trained machine-learning model using customization data associated with a particular authenticated user can satisfy the first goal, such as by improving the customized machine-learning model's capacity to provide high-quality assistance in providing patient care. In addition, removing the customization data associated with the particular authenticated user can satisfy the second goal, such as by preventing additional authenticated users from accessing the customization data via the trained machine-learning model.

In FIG. 1, a first user may utilize the client device 190 and the client application 195 to access one or more services provided by the cloud service provider platform 110. In addition, a second user may utilize the client device 180 and the client application 185 to access the services provided by the cloud service provider platform 110. In the computing environment 100, the first user and the second user can each provide respective authentication data, such as respective user identification and password information, via the client device 190 (e.g., for the first user) and the client device 180 (e.g., for the second user). The cloud service provider platform 110 determines, based on the respective authentication data, that each of the first authenticated user and the second authenticated user are authorized to access the machine-learning model 120. In addition, the cloud service provider platform 110 determines that each of the first user and the second user are authorized to access a respective portion of electronic health records that are stored in the electronic record database 105. For example, the cloud service provider platform 110 determines that the first authenticated user is authorized to access a first electronic record group 104 and the second authenticated user is authorized to access a second electronic record group 106. In some cases, each of the electronic record group 104 and the electronic record group 106 includes a subset of secured data entities stored in the electronic record database 105. In the computing environment 100, the electronic record group 104 and the electronic record group 106 are described as including different secured data entities, e.g., the first authenticated user and the second authenticated user are authorized to access different electronic health records. However, other implementations are possible, such as multiple electronic health record groups (e.g., for multiple authenticated users) that include some, all, or no electronic health records or secured data entities in common.

Based on the determination that the first authenticated user and the second authenticated user are authorized to respectively access the electronic record group 104 and the electronic record group 106, the cloud service provider platform 110 identifies respective training data entities from the electronic record group 104 and the electronic record group 106. In addition, the cloud service provider platform 110 determines respective customization training datasets based on the respective training data entities. In FIG. 1, the cloud service provider platform 110 determines a particular customization training dataset that is associated with a particular authenticated user based on particular data entities that the particular authenticated user is authorized to access. For example, the cloud service provider platform 110 determines a first customization training dataset 114 that is associated with the first authenticated user, such as by selecting one or more secured data entities from the electronic record group 104 that the first authenticated user is authorized to access. In addition, the cloud service provider platform 110 determines a second customization training dataset 116 that is associated with the second authenticated user, such as by selecting one or more secured data entities from the electronic record group 106 that the second authenticated user is authorized to access.

In the computing environment 100, the cloud service provider platform 110 customizes the machine-learning model 120 based on the customization training datasets 114 and 116. In some embodiments, a customization of the machine-learning model 120 an authenticated customization, such as a particular customization that is accessible for a particular authenticated user, e.g., accessible by a particular client device or client application via which the particular user authenticated to the cloud service provider platform 110. In addition, the cloud service provider platform 110 limits access to the authenticated customization of the machine-learning model 120, such as by preventing access by an additional authenticated user not associated with the particular customization. For example, based on the customization training dataset 114 that is associated with the first authenticated user, the cloud service provider platform 110 implements a first authenticated customization of the machine-learning model 120. In addition, the cloud service provider platform 110 permits the client device 190 and the client application 195, via which the first authenticated user provided the authentication data, to access the first authenticated customization of the machine-learning model 120. Furthermore, the cloud service provider platform 110 denies access to the first authenticated customization of the machine-learning model 120 by one or more additional client devices or client applications that are unassociated with the first authenticated user, such as the client device 180 and the client application 185. As an additional example, based on the customization training dataset 116 that is associated with the second authenticated user, the cloud service provider platform 110 implements a second authenticated customization of the machine-learning model 120. In addition, the cloud service provider platform 110 permits the client device 180 and the client application 185, via which the second authenticated user provided the authentication data, to access the second authenticated customization of the machine-learning model 120. Furthermore, the cloud service provider platform 110 denies access to the second authenticated customization of the machine-learning model 120 by one or more additional client devices or client applications that are unassociated with the second authenticated user, such as the client device 190 and the client application 195.

In the computing environment 100, the cloud service provider platform 110 removes the first and second authenticated customizations of the machine-learning model 120, such as in response to receiving data indicating that a particular authenticated user is exiting the cloud service provider platform 110 (e.g., receiving user logout data, determining a timeout period for a user session, etc.). For example, in response to receiving first data indicating that the client device 190 or the client application 195 is terminating a session with the cloud service provider platform 110 (e.g., the first user has logged out), the cloud service provider platform 110 may remove the first authenticated customization from the machine-learning model 120. In addition, in response to receiving second data indicating that the client device 180 or the client application 185 is terminating a session with the cloud service provider platform 110 (e.g., the second user has logged out), the cloud service provider platform 110 may remove the second authenticated customization from the machine-learning model 120. In some embodiments, the cloud service provider platform 110 can provide a non-customized implementation of the machine-learning model 120, such as a non-customized machine-learning model that is accessible by an unauthenticated user of the cloud service provider platform 110, or an authenticated user who is unassociated with any secured data entities in the electronic record database 105. In some embodiments, the cloud service provider platform 110 can provide a non-customized implementation of the machine-learning model 120 during a portion of an authenticated network session, such as a startup time period during which a user has begun an authenticated network session with the cloud service provider platform 110 and the cloud service provider platform 110 has not yet determined an electronic health record or customization training dataset associated with the authenticated user.

In some cases, the cloud service provider platform 110 provides improved digital assistance tools while improving security for protected patient information. For example, based on the customization training datasets 114 and 116, the customized machine-learning model 120 provide, to the first and second authenticated users, high-quality assistance that incorporates patient information from particular secured data entities that are respectively associated with the authenticated users and protects (e.g., prevents access to) additional patient information from additional secured data entities that are unassociated with the authenticated users.

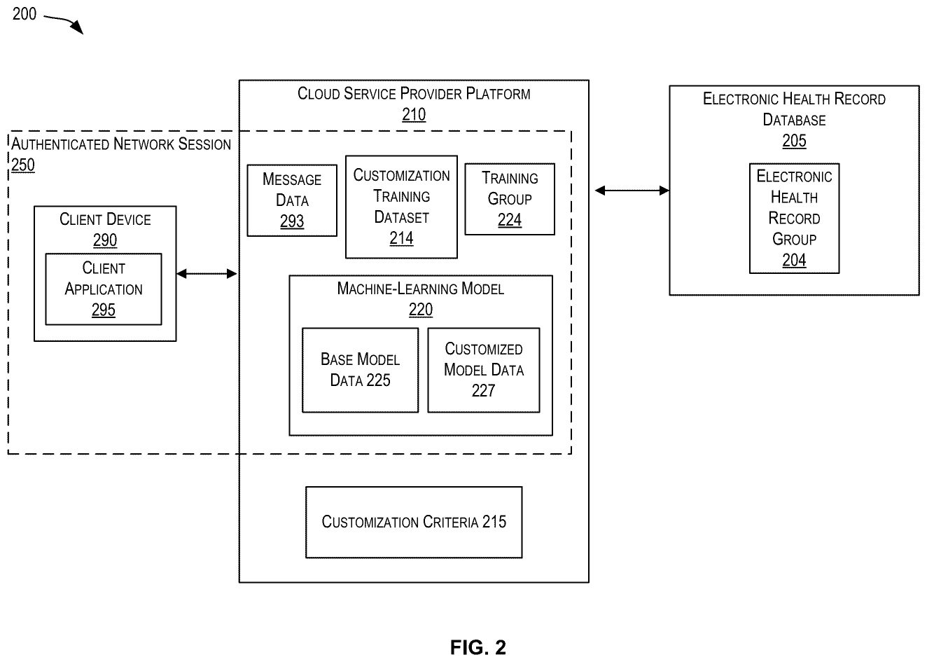

FIG. 2 shows an example of a computing environment 200, in which a cloud service provider platform 210 is configured to apply an authenticated model customization to at least one machine-learning model, such as a machine-learning model 220. In some embodiments, the cloud service provider platform 210 is included in (or otherwise configured to communicate with) a healthcare computing environment, such as the computing environment 100. In FIG. 2, the computing environment 200 includes the cloud service provider platform 210, a client device 290, and an electronic health record database 205. The cloud service provider platform 210 includes the machine-learning model 220. The client device 290 includes a client application 295 that is configured to access one or more digital assistance tools provided by the cloud service provider platform 210, such as the machine-learning model 220. The electronic health record database 205 includes one or more repositories of secured data entities, such as secured data entities describing protected patient information that are included in electronic health records. FIG. 2 describes the electronic health record database 205 as including secured data entities that describe protected patient information, but other implementations are possible. For example, a cloud service provider platform could be configured to communicate with a data repository (e.g., a database) that includes secured data entities describing additional protected information, such as protected personal information, protected financial information, protected employment information, or other types of protected information. Continuing with this example, the cloud service provider platform could be configured to generate or apply an authenticated model customization that is based on the secured data entities describing the additional protected information.

In some embodiments, the machine-learning model 220 is trained prior to use, such as pre-training that is performed prior to the cloud service provider platform 210 permitting access to the machine-learning model 220. In some embodiments, the machine-learning model 220 includes base model data 225. The base model data 225 can include vocabulary data, entity data, parameter data, weight data, vector data, layer data, or other types of model data that are generated based on the pre-training of the machine-learning model 220. In some embodiments, the machine-learning model 220 is pre-trained based on non-protected information, such as publicly available training datasets, specialty training datasets (e.g., training data related to a particular specialty, such as medical terminology, localized epidemiology data, educational diagnostic image sets, etc.), or other suitable training datasets that exclude protected information and are available to the cloud service provider platform 210 (or another computing system configured to train a machine-learning model). In addition, the base model data 225 is non-protected model data that is generated based on the non-protected information, e.g., during the pre-training of the machine-learning model 220. In FIG. 2, the machine-learning model 220 could include one or more of a speech recognition machine-learning model or a language machine-learning model.

In some embodiments, the cloud service provider platform 210 receives request data, such as message data 293, from the client device 290. The message data 293 can include (or otherwise indicate) a request to access one or more digital assistance tools provided by the cloud service provider platform 210. In some cases, the message data 293 includes authentication data, such as user identification data (e.g., username, password, biometric identification, etc.) that is associated with a user of the client device 290. In addition, the message data 293 includes timestamp data, such as timestamp data indicating a local time of the client device 290. In some embodiments, the message data 293 can include additional data related to the client device 290 or the associated user, such as location data (e.g., identifying an examination room or other location of the client device 290), data indicating additional users (e.g., multiple members of a surgery team or other care teams), or other types of data related to the client device 290 or the associated user. In FIG. 2, the message data 293 is described as being received by the cloud service provider platform 210 from the client device 290, but other implementations are possible. For example, the cloud service provider platform 210 could receive additional message data (e.g., describing a request from an additional client device) from at least one additional computing system or computing service, such as an authentication server, an event handler service, or other types of computing systems or services in communication with the cloud service provider platform 210.

Based on the message data 293, the cloud service provider platform 210 establishes an authenticated network session 250 (also referred to herein as “authenticated session 250”) with the client device 290, such as in response to determining that the authentication data in the message data 293 is valid (e.g., the user has successfully logged in). In the computing environment 200, the authenticated session 250 provides a secure communication channel between or among the cloud service provider platform 210, the client device 290, and the client application 295. In some embodiments, the cloud service provider platform 210 includes the machine-learning model 220 in the authenticated session 250, such as in response to determining, based on the message data 293, that the user of the client device 290 is authorized to access the machine-learning model 220.

In some embodiments, the cloud service provider platform 210 generates (or otherwise determines) a customization training dataset 214 that is associated with the client device 290 and accessible during the authenticated session 250. For example, the cloud service provider platform 210 determines, based on the message data 293, that the user of the client device 290 is authorized to access a particular portion of secured data entities from the electronic health record database 205, such as an electronic health record group 204. In addition, the cloud service provider platform 210 identifies a training group of secured data entities from the electronic health record group 204, such as a training group 224. Based on secured data entities in the training group 224, the cloud service provider platform 210 determines the customization training dataset 214. For example, the cloud service provider platform 210 evaluates secured data entities in the electronic health record group 204 based on one or more criteria, such as customization criteria 215. Based on the evaluation, the cloud service provider platform selects one or more secured data entities that fulfill the customization criteria 215 and includes the selected secured data entities in the training group 224. As an example in the computing environment 200, the cloud service provider platform 210 identifies the training group 224 based on an appointment criteria and multiple time criteria. For instance, the training group 224 could include data entities associated with patients who have an appointment scheduled within a forward time window (e.g., during the next seven days) or within a backward time window (e.g., during the previous seven days). In addition, the cloud service provider platform 210 generates the customization training dataset 214 using secured data entities in the training group 224. In some cases, identifying one or more secured data entities for a training group based on customization criteria can improve performance of an authenticated model customization that is applied to a machine-learning model, such as by selecting data entities for patients that are most likely to be seen by a healthcare provider during a current time window. Examples of customization criteria can include an appointment criteria (e.g., select data entities for patients with whom the user has a scheduled appointment), a time window criteria (e.g., select data entities for patients with appointments within a particular time window), a patient criteria (e.g., select data entities for a particular patient or group of patients), a location criteria (e.g., select data entities for patients with appointments at a particular office location), or other suitable criteria for selecting electronic health records or data entities stored in electronic health records. In some cases, a time window criterion can include a forward time window (e.g., a particular period of time in the future), a backward time window (e.g., a particular period of time in the past), an extended time window (e.g., a period of time extended to include a most recent appointment or quantity of appointments), or other suitable time window criteria.

During the authenticated session 250, the cloud service provider platform 210 modifies the machine-learning model 220 based on the customization training dataset 214. The modification can include an authenticated model customization of the machine-learning model 220. For example, the cloud service provider platform 210 or the machine-learning model 220 may generate customized model data 227 using one or more secured data entities that are included in the customization training dataset 214. The customized model data 227 can include customized vocabulary data, customized entity data, customized parameter data, customized weight data, customized vector data, customized layer data, or other types of customized model data that are generated based on the customization training dataset 214. In some cases, the customized model data 227 includes a combination of the base model data 225 modified by (or otherwise combined with) additional training data associated with the authenticated session 250. In the computing environment 200, the customized model data 227 is based on protected information that is associated with the authenticated user of the client device 290.

In some embodiments, the customized model data 227 is available during the authenticated session 250. For example, the user associated with the client device 290 can utilize the modified machine-learning model 220 with the customized model data 227. In some cases, the modified machine-learning model 220 with the customized model data 227 provides improved assistance to the user associated with the client device 290 during the authenticated session 250. As an example, the modified machine-learning model 220 can provide improved speech recognition of names, diagnoses, prescriptions, or other protected information for patients of the user. As an additional example, the modified machine-learning model 220 can provide more accurate diagnosis assistance using current medical information (e.g., recent screening results, upcoming appointments with specialists) for a particular patient who has an appointment with the user.

In some embodiments, the customized model data 227 is unavailable outside of the authenticated session 250. For example, an additional client device (e.g., the client device 180) that is excluded from the authenticated session 250 is unable to access the customization training dataset 214 or the customized model data 227. As an additional example, after a termination of the authenticated session 250, the client device 290 is unable to access the customization training dataset 214 or the customized model data 227. For instance, the cloud service provider platform 210 may receive additional message data indicating that the authentication session 250 has ended (e.g., the user has logged out from the client application 295, a timeout limit is reached for the session 250, etc.). Responsive to determining that the authenticated session 250 is ended, the cloud service provider platform 210 removes the customized model data 227 from the machine-learning model 220. In some embodiments, the cloud service provider platform 210 deletes or otherwise removes one or more of the training group 224 or the customization training dataset 214, such as upon termination of the authenticated session 250, upon completion of the authenticated customization of the machine-learning model 220, or based on another suitable criteria.

In some cases, the cloud service provider platform 210 removes the customized model data 227 from the machine-learning model 220 in response to determining that an additional authenticated customization is available for the associated user. For example, upon termination of the authenticated session 250, the cloud service provider platform 210 could store the customized model data 227, such as in secured storage requiring authentication by the associated user. In addition, in response to receiving additional message data initiating an additional authenticated session for the associated user (e.g., the user has logged in the next day), the cloud service provider platform 210 can determine an additional customization training dataset, such as based on one or more modified customization criteria (e.g., a time window modified for the additional authenticated session). In some embodiments, the cloud service provider platform 210 provides the customized model data 227 during a startup period, e.g., providing yesterday's authenticated customization for the user before the additional authenticated customization is available.

In FIG. 2, the cloud service provider platform 210 may generate and/or apply a particular authenticated model customization for each particular authenticated client device that accesses the machine-learning model 220. In some cases, each particular client device accesses, within a respective authenticated session for that particular device, a respective (e.g., different) authenticated model customization of the machine-learning model 220, such as a respective authenticated model customization that is generated based on respective customization training data associated with the particular authenticated client device.

In some embodiments, the cloud service provider platform 210 excludes the machine-learning model 220 from a particular authenticated network session or includes the machine-learning model 220 in the particular authenticated network session without applying an authenticated model customization. For example, based on additional message data from an additional client device, the cloud service provider platform 210 could determine that the additional message data does not include valid authentication data (e.g., a user of the additional client device has not logged in successfully). Continuing with this example, the cloud service provider platform 210 could prevent the additional client device from accessing the machine-learning model 220 (e.g., the user of the additional client device is not authorized to access the machine-learning model 220), or could permit the additional client device to access the machine-learning model 220 without an authenticated model customization (e.g., the user of the additional client device is authorized to access the machine-learning model 220 but not any secured data entities in the electronic health record database 205).

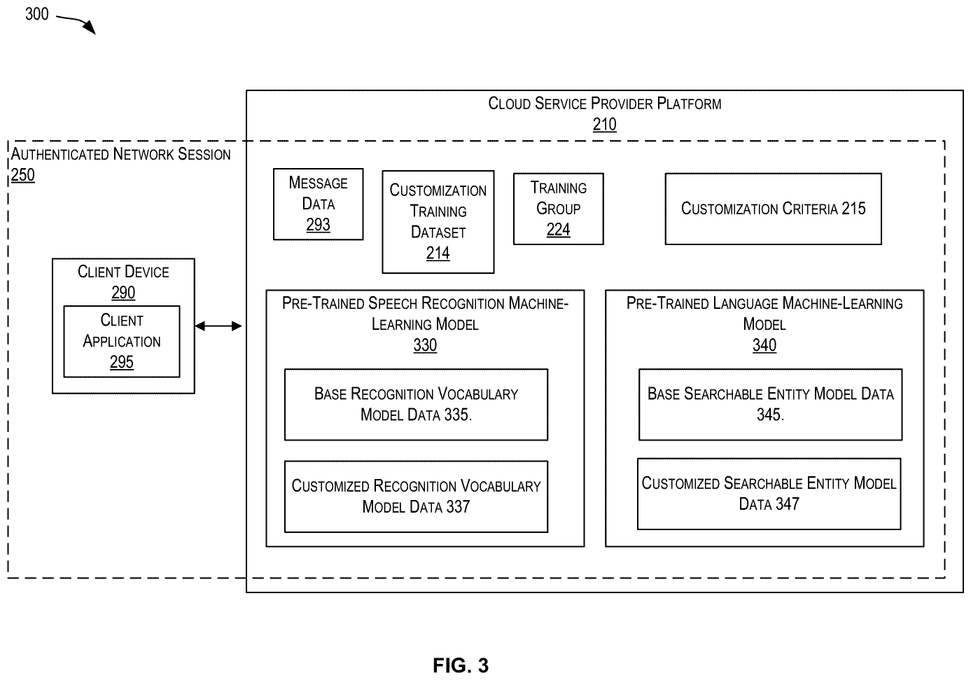

In some cases, a cloud service provider platform can include (or otherwise be configured to access) multiple machine-learning models that can be modified via an authenticated model customization. In addition, an authenticated client device can access one or more of the multiple customized machine-learning models during an authenticated network session. FIG. 3 shows an example configuration 300 of the computing environment 200, in which the cloud service provider platform 210 is configured to apply an authenticated model customization to the machine-learning model 220. In the example configuration shown in FIG. 3, the machine-learning model 220 is or includes one or more of a pre-trained speech recognition machine-learning model 330 or a pre-trained language machine-learning model 340.

In the example configuration 300, the pre-trained speech recognition machine-learning model 330 includes base recognition vocabulary model data 335 and the pre-trained language machine-learning model 340 includes base searchable entity model data 345. As generally described in regard to the base model data 225, each of the base recognition vocabulary model data 335 and the base searchable entity model data 345 is non-protected model data that is generated based on non-protected information, e.g., during pre-training of each of the pre-trained speech recognition machine-learning model 330 and the pre-trained language machine-learning model 340. In FIG. 3, the base recognition vocabulary model data 335 includes vocabulary data, such as vocabulary data that links sound data (e.g., indicating a spoken word or phrase) with text data (e.g., indicating a text word or phrase). In addition, the base searchable entity model data 345 includes searchable entity data, such as a searchable entity space in which data entities related to language are embedded (e.g., vector representations of language data entities embedded in a vector space).

In FIG. 3, the cloud service provider platform 210 establishes the authenticated session 250 with the client device 290 in response to receiving the message data 293, as generally described in regard to FIG. 2. In addition, the cloud service provider platform 210 identifies the training group 224 from the electronic health record group 204 and determines the customization training dataset 214, as generally described in regard to FIG. 2.

In the example configuration 300, during the authenticated session 250, the cloud service provider platform 210 modifies one or more of the pre-trained speech recognition machine-learning model 330 or the pre-trained language machine-learning model 340 based on the customization training dataset 214. The modification can include a first authenticated model customization for the pre-trained speech recognition machine-learning model 330 and a second authenticated model customization for the pre-trained language machine-learning model 340. For example, the cloud service provider platform 210 or the pre-trained speech recognition machine-learning model 330 can generate customized recognition vocabulary model data 337 using one or more secured data entities that are included in the customization training dataset 214. The customized recognition vocabulary model data 337 can include customized vocabulary data that links sound data with text data based on words or phrases included in the customization training dataset 214. In some cases, the customized recognition vocabulary model data 337 includes a combination of customized vocabulary data with base vocabulary data, e.g., from the base recognition vocabulary model data 335. In addition, the cloud service provider platform 210 or the pre-trained language machine-learning model 340 can generate customized searchable entity model data 347 using one or more secured data entities that are included in the customization training dataset 214. The customized searchable entity model data 347 can include customized searchable entity data related to words or phrases included in the customization training dataset 214. In some cases, the customized searchable entity model data 347 includes a combination of customized searchable entity data with base searchable entity data, e.g., a customized searchable entity space in which customized data entities related to language from the customization training dataset 214 and also base data entities related to language from pre-training are embedded.

In some embodiments, the customized recognition vocabulary model data 337 and the customized searchable entity model data 347 are available during the authenticated session 250. For example, the user associated with the client device 290 can utilize one or more of the modified pre-trained speech recognition machine-learning model 330 or the modified pre-trained language machine-learning model 340. In some cases, the modified pre-trained speech recognition machine-learning model 330 with the customized recognition vocabulary model data 337 provides improved assistance to the user associated with the client device 290 during the authenticated session 250, such as by performing speech recognition tasks related patient information with improved accuracy. For example, the modified pre-trained speech recognition machine-learning model 330 may recognize and transcribe (e.g., perform speech-to-text tasks) a patient's name with improved accuracy based on the customized recognition vocabulary model data 337. In addition, the modified pre-trained language machine-learning model 340 with the customized searchable entity model data 347 provides improved assistance to the user associated with the client device 290 during the authenticated session 250, such as by performing language analysis tasks related to patient information with improved accuracy. For example, the modified pre-trained language machine-learning model 340 may identify correlations among events in a patient's medical history with improved accuracy based on the customized searchable entity model data 347.

In some embodiments, the customized recognition vocabulary model data 337 and the customized searchable entity model data 347 are unavailable outside of the authenticated session 250. For example, an additional client device that is excluded from the authenticated session 250 is unable to access the customized recognition vocabulary model data 337 or the customized searchable entity model data 347. As an additional example, after a termination of the authenticated session 250, the client device 290 is unable to access the customized recognition vocabulary model data 337 or the customized searchable entity model data 347. For example, responsive to determining that the authenticated session 250 is ended, the cloud service provider platform 210 removes the customized recognition vocabulary model data 337 from the pre-trained speech recognition machine-learning model 330 and the customized searchable entity model data 347 from the pre-trained language machine-learning model 340. In some cases, removing the customized recognition vocabulary model data 337 from the pre-trained speech recognition machine-learning model 330 can include one or more of deleting the customized recognition vocabulary model data 337 or restoring the base recognition vocabulary model data 335. In addition, removing the customized searchable entity model data 347 from the pre-trained language machine-learning model 340 can include one or more of deleting the customized searchable entity model data 347 or restoring the base searchable entity model data 345.

### Illustrative Method(s)

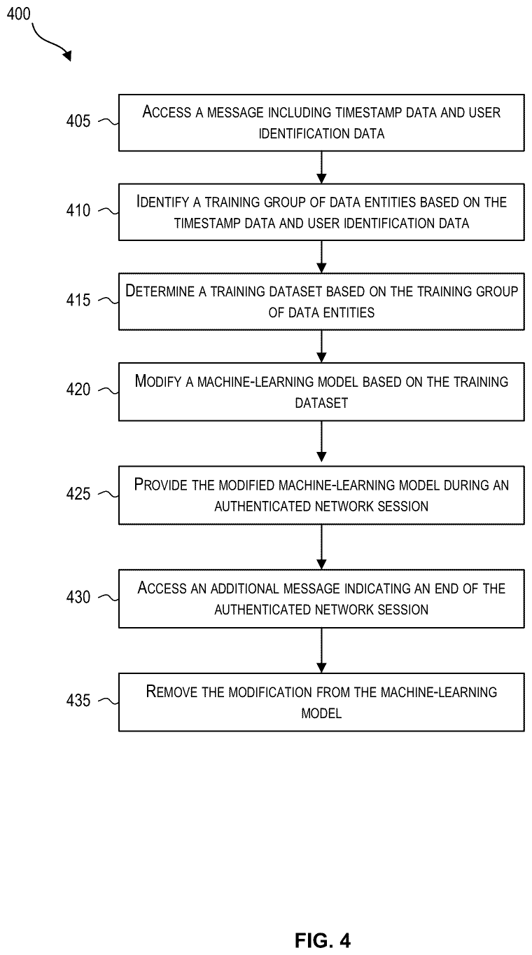

FIG. 4 depicts a process flow 400 for generating an authenticated customization for a machine-learning model. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-3, the processing depicted in FIG. 4 may be performed by a computing system (e.g., the cloud service provider platform 110 or the cloud service provider platform 210) to apply an authenticated model customization to a machine-learning model.

At block 405, a message is accessed by a computing system. In some cases, the computing system is a cloud service provider platform as described with respect to FIGS. 1-3. The message includes timestamp data and user identification data, at least. In some cases, the cloud service provider platform receives the message as data, such as request data or event data from a client device, an authentication service, or another suitable computing system. In some cases, the message indicates a request to access one or more digital assistance tools provided by the cloud service provider platform, such as a request from a client device.

At block 410, a training group of data entities is identified based on data included in the message, such as the timestamp data and the user identification data. In the training group, each data entity fulfills a set of customization criteria, such as customization criteria that are associated with the cloud service provider platform, the one or more digital assistance tools, a user who is associated with the user identification data, etc. In some cases, the cloud service provider platform generates the training group based on a selection of particular data entities that fulfill one or more customization criteria. The training group of data entities can include secured data entities, such as data objects that include or otherwise represent protected information. In some cases, the cloud service provider platform generates the training group based on a selection of particular secured data entities for which the user identification data (or other data in the message) authorizes access.

At block 415, at least one training dataset is determined based on the training group of data entities. The training dataset can be a customization training dataset that is associated with a machine-learning model. The training dataset includes data entities, such as secured data entities, that are extracted from or otherwise determined based on the training group of data entities. For example, the cloud service provider platform generates the training dataset by determining, from the training group of data entities, one or more data entities or other types of data that are suitable for customizing the machine-learning model. In some cases, the cloud service provider platform determines multiple training datasets that are respectively associated with multiple machine-learning models. For example, the cloud service provider platform could generate a speech recognition training dataset that is associated with a speech recognition machine-learning model. In addition, the cloud service provider platform could generate a language training dataset that is associated with a language machine-learning model.

At block 420, at least one machine-learning model is modified based on the at least one training dataset. Modifying the machine-learning model includes customization based on the training dataset. For example, the cloud service provider platform can modify a particular machine-learning model by applying a particular customization training dataset, as described with respect to FIGS. 2-3. In some cases, the cloud service provider platform modifies multiple machine-learning models by respectively applying multiple training datasets. For example, the cloud service provider platform could modify the speech recognition machine-learning model by applying the associated speech recognition training dataset. In addition, the cloud service provider platform could modify the language machine-learning model by applying the associated language training dataset. In some embodiments, the cloud service provider platform may delete one or more of the training dataset or the training group of data entities, such as in response to determining that the particular customization training dataset has been applied to the particular machine-learning model.

At block 425, at least one modified machine-learning model is provided during an authenticated network session. Providing the modified machine-learning model can include permitting access by at least one computing system that is included in the authenticated network session. For example, the cloud service provider platform can permit an authenticated client device that is associated with the user identification data to access the modified machine-learning model during the authenticated network session. In some cases, additional computing systems not included in the authenticated network session are denied access to the modified machine-learning model, such as additional computing systems that have additional authenticated network session unassociated with the user identification data.

At block 430, an additional message is accessed by the computing system, such as an additional message received by the cloud service provider platform. The additional message includes data that modifies the authenticated network session. In some cases, the additional message could include data that indicates an end of the authenticated network session, such as data indicating that a user associated with the user identification data has logged out of the authenticated network session.

At block 435, the at least one modification is removed from the at least one machine-learning model. In some cases, removing the modification from the machine-learning model is in response to determining that the authenticated network session has ended. For example, based on the additional message, the cloud service provider platform can determine that the authenticated network session associated with the user identification data has ended. Responsive to determining that the authenticated network session has ended, the cloud service provider platform may remove the customization training dataset from the machine-learning model that had been customized. In some cases, the cloud service provider platform may remove the customization training dataset from the machine-learning model in response to determining that a modified customization training dataset has been generated, e.g., a modified customization training dataset updated based on an additional authentication network session for the associated authenticated user. In some cases, the cloud service provider platform removes multiple modifications from multiple machine-learning models. For example, the cloud service provider platform could remove the speech recognition training dataset from the speech recognition machine-learning model. In addition, the cloud service provider platform could remove the language training dataset from the language machine-learning model.

In some embodiments, a training dataset removed from a machine-learning model is deleted by the cloud service provider platform. In some embodiments, a training dataset removed from a machine-learning model is stored by the cloud service provider platform, such as saving a particular customization training dataset for a particular user. For example, the cloud service provider platform could securely store a removed customization training dataset in secured storage that prevents additional computing systems (e.g., not associated with the authenticated network session) from accessing the removed customization training dataset. In some cases, a removed customization training dataset is retained for a particular period of time, such as until the modification of the machine-learning model is completed, for a quantity of time (e.g., hours, minutes) following a user logout, until an end of a user's shift (e.g., based on scheduling data associated with the user), or for another suitable period of time. In some cases, the cloud service provider platform deletes the removed customization training dataset upon completion of the particular period of time.

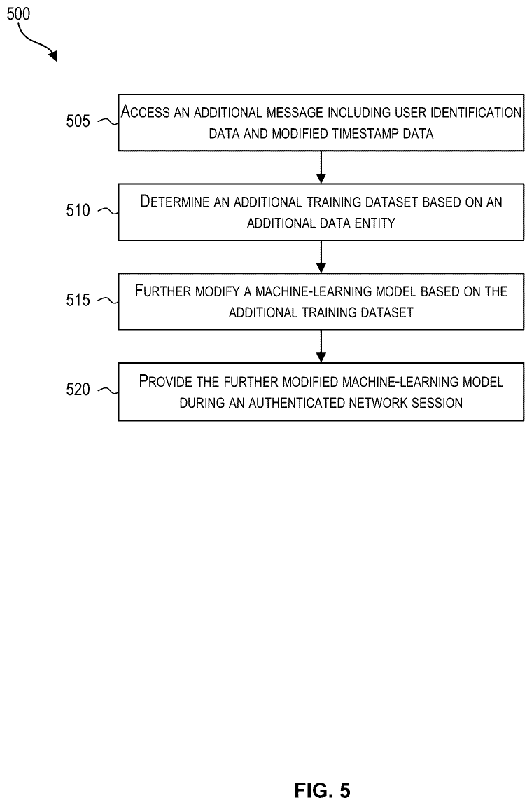

FIG. 5 depicts a process flow 500 for modifying an authenticated customization for a machine-learning model. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-4, the processing depicted in FIG. 5 may be performed by a computing system (e.g., the cloud service provider platform 110 or the cloud service provider platform 210) to modify an authenticated model customization for a machine-learning model, such as based on a modification of an authenticated network session.

In some embodiments, one or more of the operations described with respect to FIG. 5 are performed in parallel with, or in the alternative from, or in addition to one or more of the operations described with respect to FIG. 4. For example, the cloud service provider platform described with respect to FIG. 4 could perform one or more of the operations described with respect to FIG. 5 subsequent to receiving a first message requesting access to a digital assistance tool (e.g., as described at block 405) and prior to receiving a second message indicating an end of an authenticated network session (e.g., as described at block 430).

At block 505, a message is accessed by a computing system. In some embodiments, the computing system is a cloud service provider platform as described with respect to FIGS. 1-4. In some cases, the accessed message is an additional message, such as an additional message received subsequent to the message described with respect to block FIG. 4. The cloud service provider platform determines that the additional message includes data that modifies an authenticated network session, such as the authenticated network session associated with the user identification data described with respect to block FIG. 4. In some cases, the cloud service provider platform determines that the additional message includes data modifying and continuing the authenticated network session (e.g., a modification that does not end the session).

In some cases, as described with respect to FIG. 4, the additional message could include data that indicates an end of the authenticated network session, such as data indicating that a user associated with the user identification data has logged out of the authenticated network session. As an additional example, the additional message could include data that indicates a modification of the authenticated network session, such as modified timestamp data indicating a modified date (e.g., the user is logged on during an overnight shift). Additional examples of data modifying the authenticated network session could include identification data indicating a modified computing system (e.g., the user has logged in on an additional client device), location data (e.g., the user has moved the logged-in client device to another examination room) or other types of data indicating modifications for the authenticated network session.

At block 510, one or more of an additional data entity or an additional training dataset are determined. For example, based on modified timestamp data included in the additional message, the cloud service provider platform identifies at least one additional data entity that fulfills one or more customization criteria, such as an appointment criteria and a time criteria based on the modified time data. In some cases, the cloud service provider platform modifies a training group of data entities, such as described with respect to block 410, to include the additional data entity. In addition, the cloud service provider platform determines an additional training dataset based on the additional data entity. For example, the cloud service provider platform could modify the training dataset described in regard to block 415 to include the additional data entity. In some cases, the cloud service provider platform further modifies the training group of data entities or the training dataset to omit a particular data entity, such as removing a data entity that no longer fulfills the customization criteria based on the modified timestamp data.

At block 515, at least one machine-learning model is modified, or further modified, based on the additional training dataset. Modifying the machine-learning model includes customization, or further customization, based on the additional training dataset. In some cases, the cloud service provider platform applies multiple training datasets to a particular machine-learning model. For example, the cloud service provider platform can apply the additional training dataset to the modified machine-learning model described with respect to block 420. In some cases, the cloud service provider platform removes a previous applied training dataset from a particular machine-learning model prior to applying the additional training set. For example, the cloud service provider platform can remove the training dataset from the modified machine-learning model described with respect to block 420 prior to applying the additional training dataset to the machine-learning model.

At block 520, the modified machine-learning model, or further modified machine-learning model, is provided during an authenticated network session, such as during the authenticated network session described with respect to block 425. For example, the cloud service provider platform can permit the authenticated client device associated with the user identification data to access the further modified machine-learning model during the authenticated network session. In some cases, additional computing systems not included in the authenticated network session are denied access to the further modified machine-learning model.

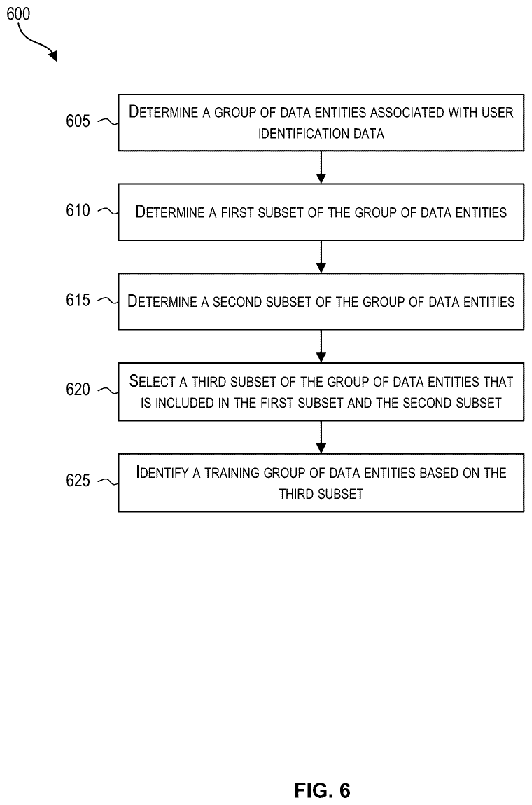

FIG. 6 depicts a process flow 600 for determining a training group of data entities, from which an authenticated customization for a machine-learning model can be determined. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 1-5, the processing depicted in FIG. 6 may be performed by a computing system (e.g., the cloud service provider platform 110 or the cloud service provider platform 210) to determine a training group of data entities based on which an authenticated model customization for a machine-learning model could be generated.

In some embodiments, one or more of the operations described with respect to FIG. 6 are performed in parallel with, or in the alternative from, or in addition to one or more of the operations described with respect to FIGS. 4-5. For example, the cloud service provider platform described with respect to FIG. 4 could perform one or more of the operations described with respect to FIG. 6 in relation to identifying a training group of data entities (e.g., as described at block 410).

At block 605, a group of one or more data entities associated with user identification data are determined. The determined data entities can be secured data entities, such as secured data entities extracted from (or otherwise determined from) one or more electronic health records. In some cases, the user identification data is included in a message received by a cloud service provider platform, such as described with respect to block 405. For example, the cloud service provider platform could identify the group of data entities based on at least one electronic health record that a healthcare provider associated with the user identification data is authorized to access, such as an electronic health record for a patient of the healthcare provider.

At block 610, a first subset of the group of one or more data entities is determined. In some cases, the first subset is determined based on first customization criteria. For example, the cloud service provider platform can determine the first subset by identifying which data entities from the group of data entities fulfill the first customization criteria. In some cases, the first customization criteria are one or more appointment criteria. For example, the cloud service provider platform can determine the first subset of data entities based on appointment criteria indicating patients who have an appointment scheduled with the healthcare provider associated with the user identification data.

At block 615, a second subset of the group of one or more data entities is determined. In some cases, the second subset is determined based on second customization criteria. For example, the cloud service provider platform can determine the second subset by identifying which data entities from the group of data entities fulfill the second customization criteria. In some cases, the second customization criteria are one or more time criteria. For example, the cloud service provider platform can determine the second subset of data entities based on time criteria indicating a particular time window associated with appointments, such as a forward time window, a backward time window, an extended time window (e.g., determining a most recent n appointments), or another suitable time window that includes appointments for the healthcare provider.

In some embodiments, one or more additional subsets of the group of one or more data entities are determined, based on one or more additional customization criteria. For example, the cloud service provider platform could determine the additional subsets by identifying which data entities from the group of data entities fulfill the additional customization criteria.

At block 620, a third subset of the group of one or more data entities is determined. In addition, the third subset is selected from the data entities that are included in the first subset and the second subset. In some cases, the third subset is selected from the data entities that are included in a combination of the first subset, the second subset, and the one or more additional subsets. For example, the cloud service provider platform selects the third subset based on one or more data entities that are included in both the first subset and second subset, e.g., data entities that fulfill the first and second customization criteria. In some embodiments, the cloud service provider platform selects the third subset based on data entities that are included in all determined subsets, e.g., data entities that fulfill the first, second, and the additional customization criteria.

At block 625, a training group of data entities is identified based on the third subset of the group of one or more data entities. In the training group, each data entity fulfills the customization criteria evaluated by the cloud service provider platform, such as the appointment criteria, the time criteria, and the additional customization criteria. For example, the cloud service provider platform identifies the training group of data entities described with respect to block 410 based on the third subset of data entities.

### Examples of Cloud Infrastructure

The term cloud service is generally used to refer to a service that is made available by a cloud service provider (CSP) to users (e.g., cloud service customers) on demand (e.g., via a subscription model) using systems and infrastructure (e.g., cloud infrastructure) provided by the CSP. Examples of a CSP can include the cloud service provider platform 110 or the cloud service provider platform 210. Typically, the servers and systems that make up the CSP's infrastructure are separate from the user's own on-premise servers and systems. Users can thus avail themselves of cloud services provided by the CSP without having to purchase separate hardware and software resources for the services. Cloud services are designed to provide a subscribing user easy, scalable access to applications and computing resources without the user having to invest in procuring the infrastructure that is used for providing the services.

There are several cloud service providers that offer various types of cloud services. As discussed herein, there are various types or models of cloud services including infrastructure as a service (IaaS), software as a service (SaaS), platform as a service (PaaS), and others. A user can subscribe to one or more cloud services provided by a CSP. The user can be any entity such as an individual, an organization, an enterprise, and the like. When a user subscribes to or registers for a service provided by a CSP, a tenancy or an account is created for that user. The user can then, via this account, access the subscribed-to one or more cloud resources associated with the account.

As noted above, IaaS is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

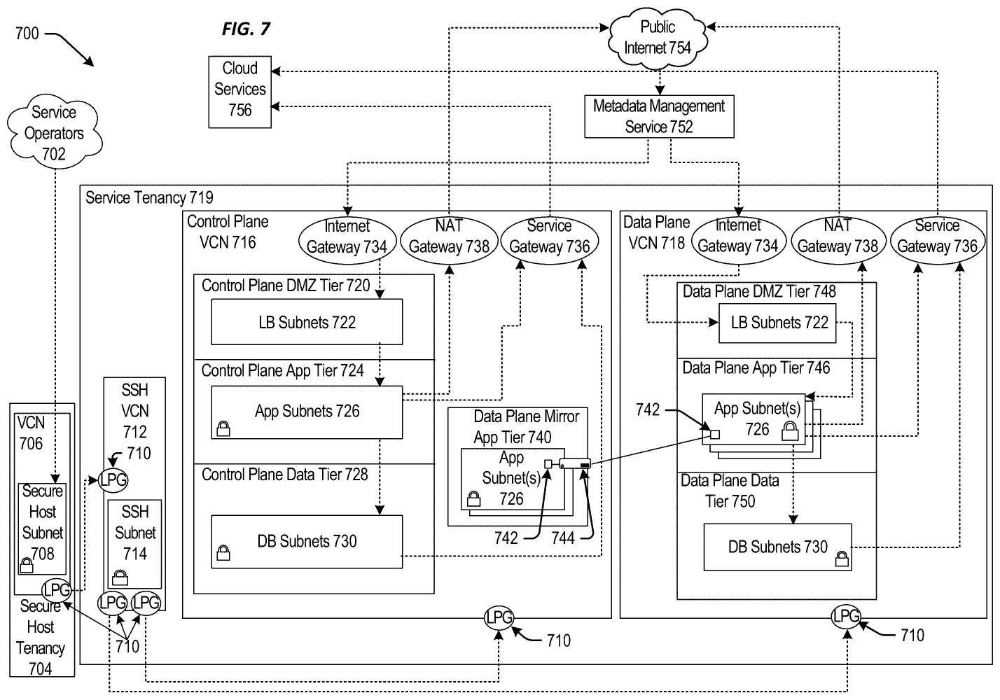

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

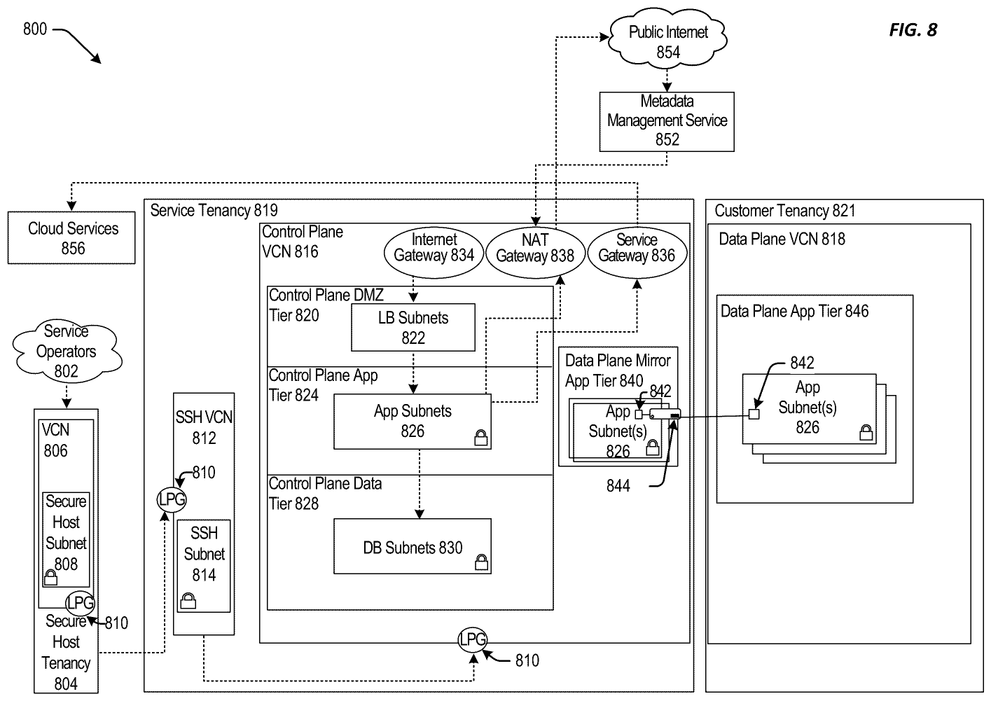

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 706 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 810 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

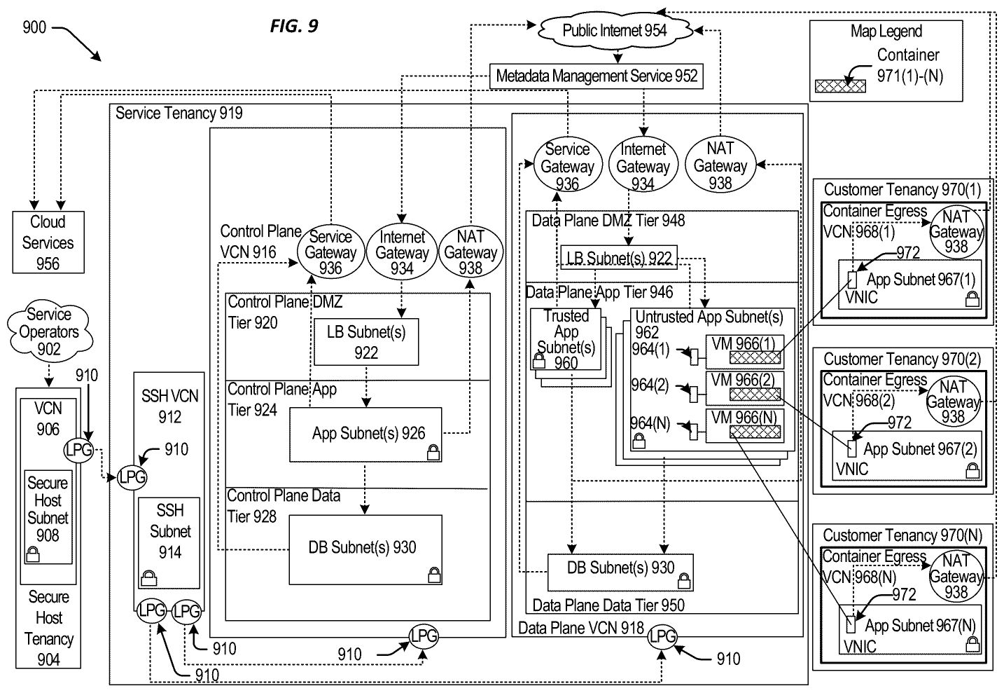

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management service 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 970(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

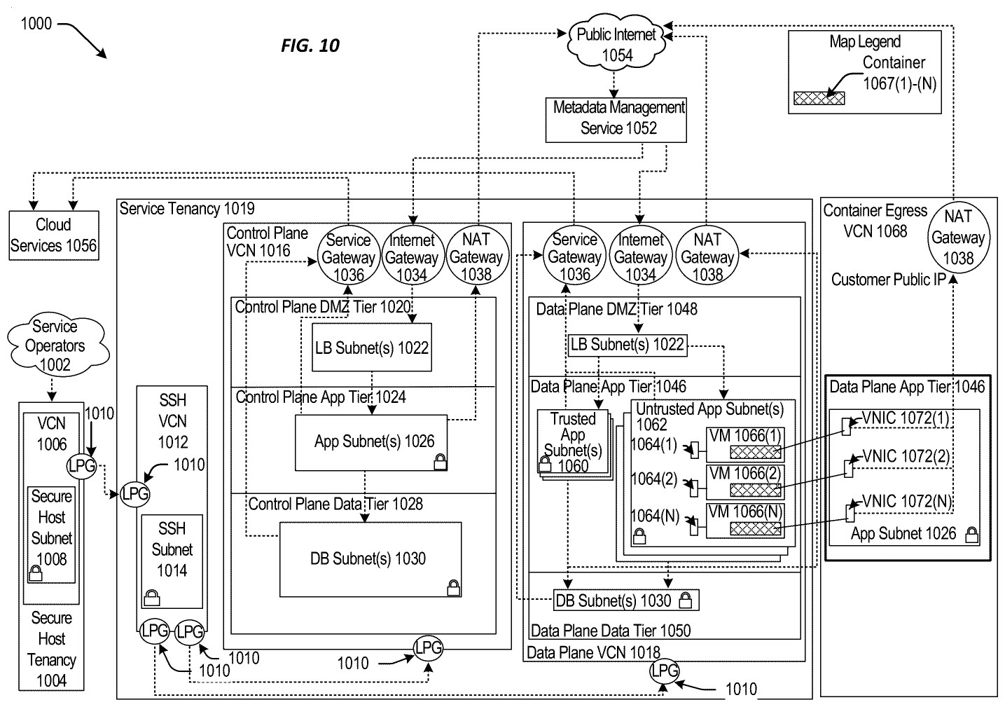

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management service 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the tenant VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

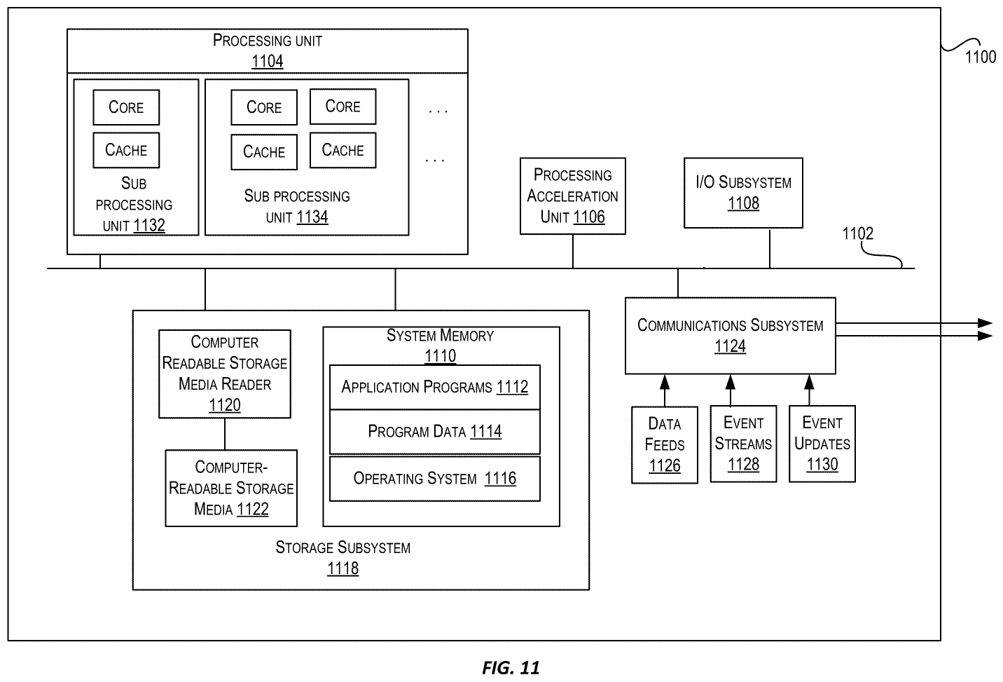

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some, or all of the program code to be executed can be resident in processing unit(s) 1104 and/or in storage subsystem 1118. Through suitable programming, processing unit(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable, and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.12 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

As used herein, when an action is “based on” something, this means the action is based at least in part on at least a part of the something. As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing a message that includes timestamp data and user identification data;
identifying a training group of data entities including patient information, wherein each data entity in the training group:
(i) is included in an appointment dataset associated with the user identification data, and
(ii) includes appointment time data within a time window that is based on the timestamp data;
determining, based on the training group of the data entities, at least one training dataset;
modifying at least one pre-trained machine-learning model based on the at least one training dataset; and
providing, during an authenticated network session associated with the user identification data, the at least one modified pre-trained machine-learning model.

2. The computer-implemented method of claim 1, further comprising:
accessing an additional message indicating an end of the authenticated network session associated with the user identification data; and
removing, from the at least one pre-trained machine-learning model, the modification that is based on the at least one training dataset.

3. The computer-implemented method of claim 1, wherein the training group of the data entities comprises secured data entities, and the authenticated network session grants access, to a client device that is authenticated via the user identification data, to the patient information included in the secured data entities.

4. The computer-implemented method of claim 1, wherein the message is generated in response to a client application executing on a client device associated with the user identification data, the message indicating that the client application is granted access to a computing resource.

5. The computer-implemented method of claim 1, wherein the time window includes one or more of:
(a) a forward time window including a first period of time subsequent to the timestamp data,
(b) a backwards time window including a second period of time prior to the timestamp data, or
(c) an extended time window in which a most recent appointment time data item is included.

6. The computer-implemented method of claim 1, further comprising:
during the authenticated network session, accessing an additional message that includes the user identification data and modified timestamp data;
determining an additional training dataset that is based on at least one additional data entity, the additional data entity (i) being included in the appointment dataset associated with the user identification data, and (ii) including additional appointment time data that is within an additional time window based on the additional timestamp data;
further modifying the at least one pre-trained machine-learning model based on the additional training dataset; and
providing, during the authenticated network session associated with the user identification data, the at least one further modified pre-trained machine-learning model.

7. The computer-implemented method of claim 6, wherein further modifying the at least one pre-trained machine-learning model further comprises removing, from the at least one pre-trained machine-learning model, the modification that is based on the at least one training dataset.

8. The computer-implemented method of claim 1, wherein identifying the training group of data entities further comprises:
determining a group of data entities associated with the user identification data;
determining a first subset of the group of data entities, wherein each data entity included in the first subset is included in the appointment dataset associated with the user identification data;
determining a second subset of the group of data entities, wherein each data entity included in the second subset includes the appointment time data within the time window; and
selecting, from the group of data entities associated with the user identification data, a third subset of the group of data entities, wherein each data entity in the third subset is included in the first subset and the second subset,
wherein the training group of the data entities includes each data entity included in the third subset.

9. The computer-implemented method of claim 1, wherein:
the at least one pre-trained machine-learning model comprises a speech recognition pre-trained machine-learning model;
the at least one training dataset comprises a speech recognition training dataset;
determining the speech recognition training dataset comprises:
extracting, from the training group of the data entities, text data associated with the patient information included in the training group of the data entities, and
generating a customization recognition vocabulary that includes the extracted text data, wherein the speech recognition training dataset includes the customization recognition vocabulary; and
the modifying the at least one pre-trained machine-learning model based on the at least one training dataset comprises modifying the speech recognition pre-trained machine-learning model based on the speech recognition training dataset

10. The computer-implemented method of claim 9, further comprising:
accessing an additional message indicating an end of the authenticated network session associated with the user identification data; and
removing, from the speech recognition pre-trained machine-learning model, the speech recognition training dataset that includes the customization recognition vocabulary.

11. The computer-implemented method of claim 1, wherein:
the at least one pre-trained machine-learning model comprises a language pre-trained machine-learning model;
the at least one training dataset comprises a language training dataset;
determining the language training dataset comprises:
identifying, in the training group of the data entities, a group of data objects associated with the patient information included in the training group of the data entities; and
modifying, for each particular data object in the group of data objects, a respective searchable data entity to include the particular data object, wherein the language training dataset includes the respective searchable data entity for each particular data object in the group of data objects; and
the modifying the at least one pre-trained machine-learning model based on the at least one training dataset comprises modifying the language pre-trained machine-learning model based on the language training dataset.

12. The computer-implemented method of claim 11, further comprising:
accessing an additional message indicating an end of the authenticated network session associated with the user identification data; and
removing, from the language pre-trained machine-learning model, the language training dataset that includes the respective searchable data entity for each particular data object in the group of data objects.

13. A system comprising:
one or more processing systems; and
one or more computer-readable media storing instructions which, when executed by the one or more processing systems, cause the system to perform operations comprising:
accessing a message that includes timestamp data and user identification data;
identifying a training group of secured data entities including patient information, wherein each secured data entity in the training group:
(i) is included in an appointment dataset associated with the user identification data, and
(ii) includes appointment time data within a time window that is based on the timestamp data;
determining, based on the training group of the secured data entities, at least one training dataset;
modifying at least one pre-trained machine-learning model based on the at least one training dataset; and
providing, during an authenticated network session associated with the user identification data, the at least one modified pre-trained machine-learning model.

14. The system of claim 13, the operations further comprising:
accessing an additional message indicating an end of the authenticated network session associated with the user identification data; and
removing, from the at least one pre-trained machine-learning model, the modification that is based on the at least one training dataset.

15. The system of claim 13, wherein the training group of the data entities comprises secured data entities, and the authenticated network session grants access, to a client device that is authenticated via the user identification data, to the patient information included in the training group of the secured data entities.

16. The system of claim 13, wherein the time window includes one or more of:
(a) a forward time window including a first period of time subsequent to the timestamp data,
(b) a backwards time window including a second period of time prior to the timestamp data, or
(c) an extended time window in which a most recent appointment time data item is included.

17. One or more non-transitory computer-readable media storing instructions which, when executed by one or more processors, cause a system to perform operations comprising:
accessing a message that includes timestamp data and user identification data;
identifying a training group of data entities including patient information, wherein each data entity in the training group:
(i) is included in an appointment dataset associated with the user identification data, and
(ii) includes appointment time data within a time window that is based on the timestamp data;
determining, based on the training group of the data entities, at least one training dataset;
modifying at least one pre-trained machine-learning model based on the at least one training dataset; and
providing, during an authenticated network session associated with the user identification data, the at least one modified pre-trained machine-learning model.

18. The one or more non-transitory computer-readable media of claim 17, the operations further comprising:
accessing an additional message indicating an end of the authenticated network session associated with the user identification data; and
removing, from the at least one pre-trained machine-learning model, the modification that is based on the at least one training dataset.

19. The one or more non-transitory computer-readable media of claim 17, wherein the training group of the data entities comprises secured data entities, and the authenticated network session grants access, to a client device that is authenticated via the user identification data, to the patient information included in the training group of the secured data entities.

20. The one or more non-transitory computer-readable media of claim 17, wherein the time window includes one or more of:
(a) a forward time window including a first period of time subsequent to the timestamp data,
(b) a backwards time window including a second period of time prior to the timestamp data, or
(c) an extended time window in which a most recent appointment time data item is included.
